(19) United States
(12) Patent Application Publication
(10) Pub. No.: US 2002/0190031 A1
(43) Pub. Date: Dec. 19, 2002

(54) Electrical discharge machining apparatus

(76) Inventor: Martin Hall, Syston (GB)

Correspondence Address: YOUNG & BASILE, P.C., Suite 624, 3001 West Big Beaver Road, Troy, MI, 48084-3107, US

(21) Appl. No.: 10/163,955

(22) Filed: Jun. 6, 2002

(30) Foreign Application Priority Data
Jun. 7, 2001 (GB) GB 0113879.1

(51) Int. Cl. B23H 1/00; B23H 7/30

(52) U.S. Cl. 219/69.2

(57) ABSTRACT

An electrical discharge machining apparatus 10 comprises an electrode assembly 40 having an electrode clamp 54 for clamping a hollow electrode 24. Dielectric fluid is directed through the hollow interior of the electrode 24 to a workpiece 14. A deformable seal 70 seals between the electrode 24 and the assembly 40, and is moveable between a relaxed position (see FIG. 3) in which dielectric fluid can flow between the seal 70 and the assembly 40, and an operative position (see FIG. 5) in which the seal is deformed, and seals between the electrode and the assembly 40. A piston 74 actuates the clamp 54 and also caused deformation of the seal 70. The clamp 54 and seal 70 are capable of receiving an electrode 24 having an external diameter within a 200 micron range.

Electrical discharge machining (EDM) is used widely to machine perforations or cavities in electrically conductive metals. The process is used, for example, in the production of bores and features, both cylindrical and otherwise shaped, in gas turbine engine components and in turbine blades and veins especially.

It has been found advantageous during machining to utilise tubular electrodes and to flow dielectric fluid, normally deionised water, through the tubular electrodes towards the workpiece being machined. The dielectric fluid assists flushing eroded debris from a bore being machined whilst at the same time cooling the electrode, allowing higher electrical currents to be used. This arrangement enables significantly faster drilling whilst at the same time achieving the required metallurgical criteria. The dielectric fluid utilised is under sufficient pressure to allow fluid to pass through the length of the tubular electrode towards the workpiece. This requirement involves providing fluid under a pressure of typically 1000 psi, that is approximately 6900 kN/m², at the inner end of the electrode or electrodes.

It has also been found advantageous to rotate the electrode when machining a hole or feature. The rotation of an electrode further increases its machining rate, and assists further in the removal of debris from the machining site.

It is an aim of the invention to provide a rotatable clamp and seal, which are capable of receiving a range of different sizes of electrode.

The invention will now be described, by way of example only, with reference to the following drawings in which:

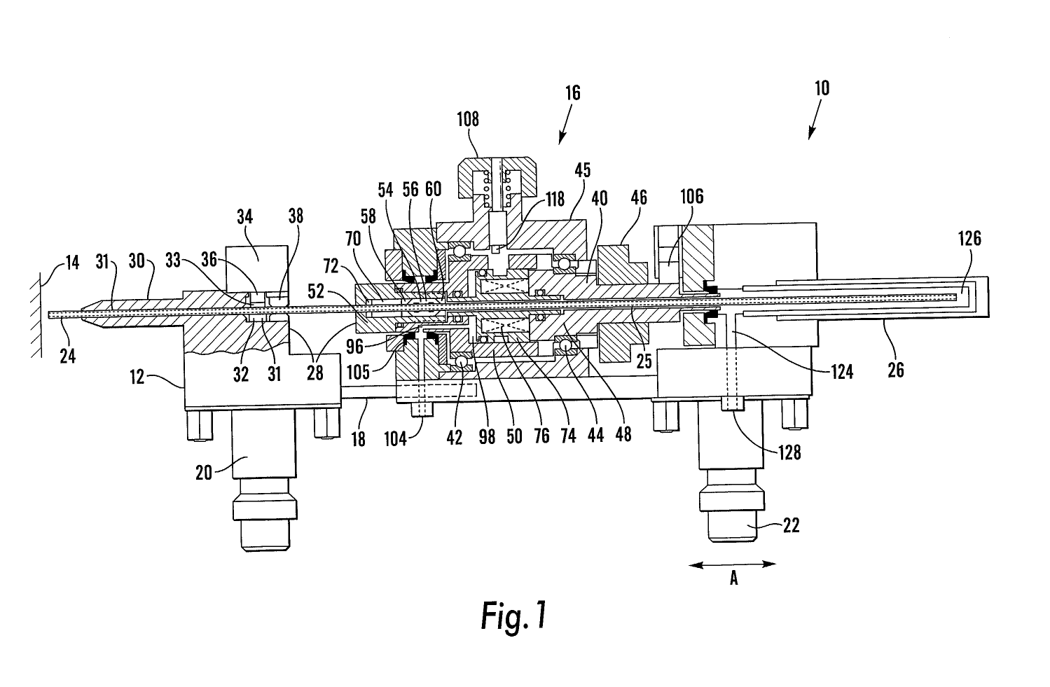

FIG. 1 is a diagrammatic sectional view of an EDM apparatus;

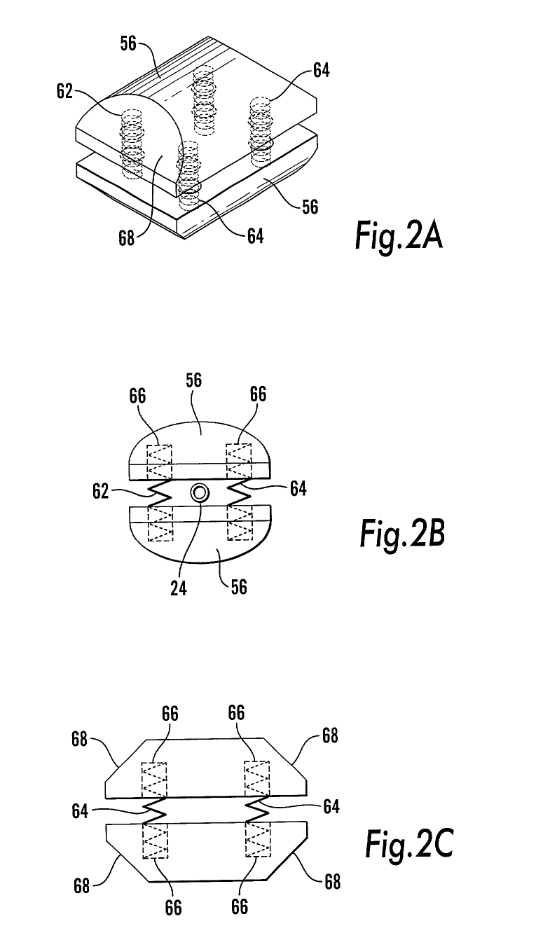

FIG. 2A is a diagrammatic perspective view of the jaws of an electrode clamp for use in the apparatus of FIG. 1;

FIG. 2B is an end view of the jaws of FIG. 2A;

FIG. 2C is a side view of the jaws of FIGS. 2A and 2B;

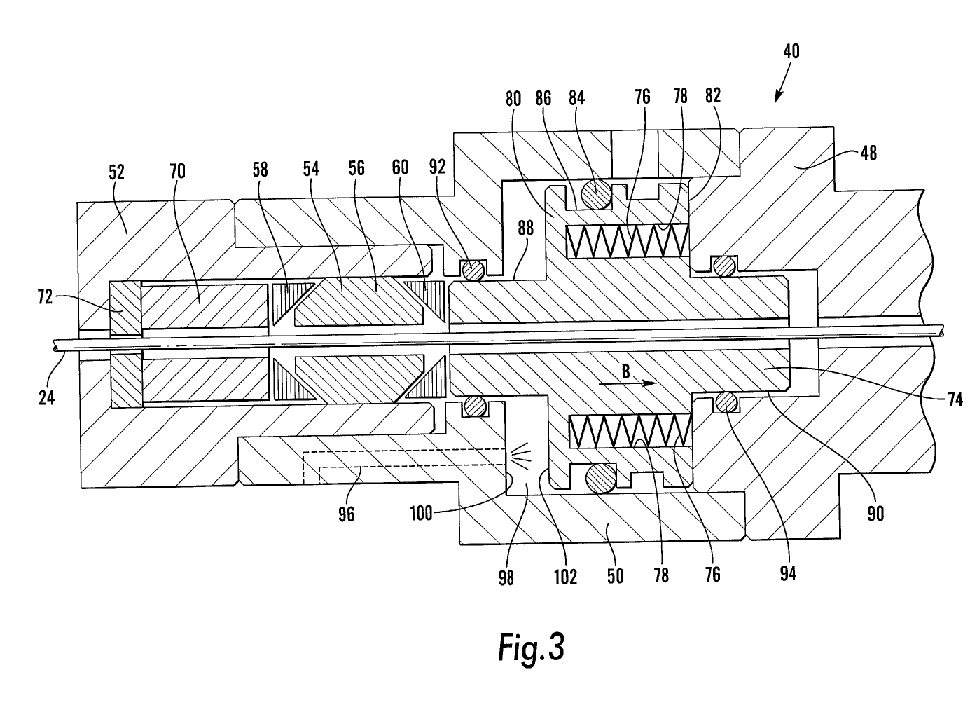

FIG. 3 is an enlarged sectional view of part of the EDM apparatus shown in FIG. 1, with an unclamped electrode;

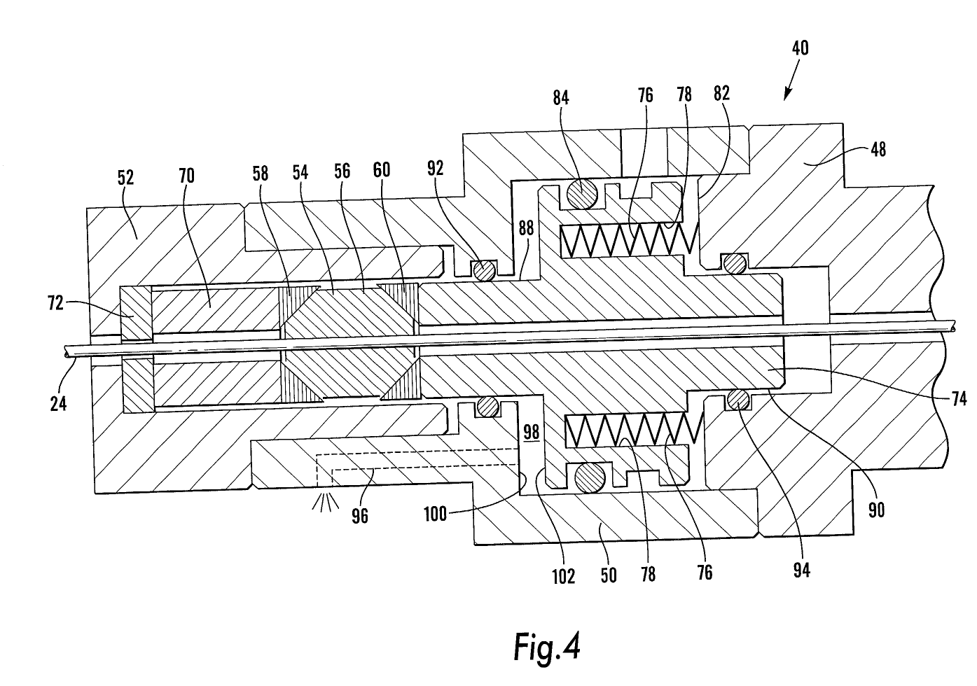

FIG. 4 is an enlarged sectional view of the part of the EDM apparatus shown in FIG. 3, with the electrode clamped;

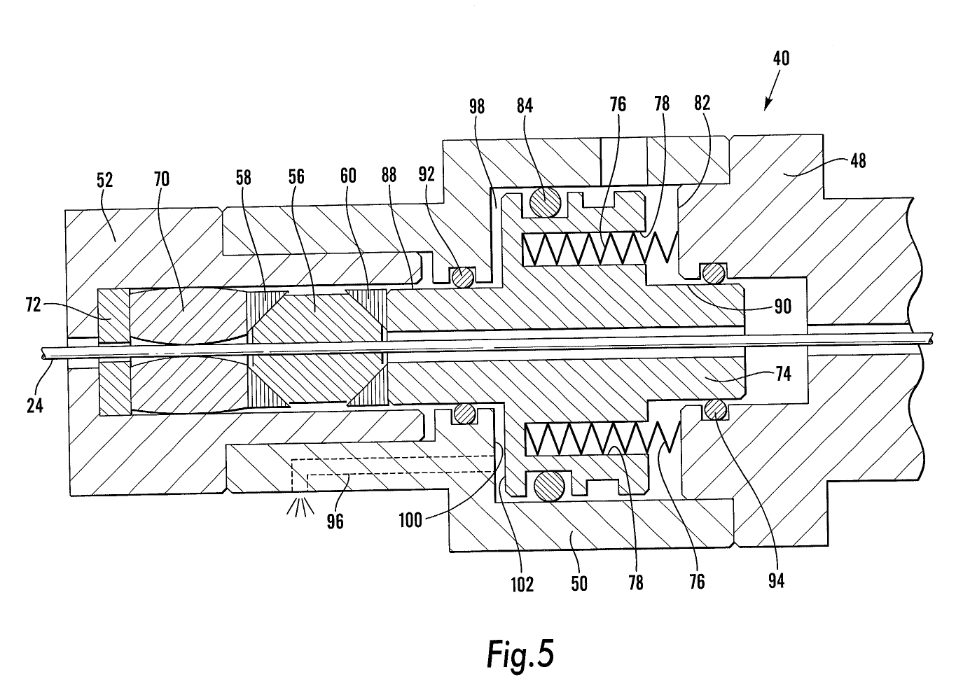

FIG. 5 is an enlarged sectional view of the part of the EDM apparatus shown in FIGS. 3 and 4, with the electrode clamped and sealed against the apparatus;

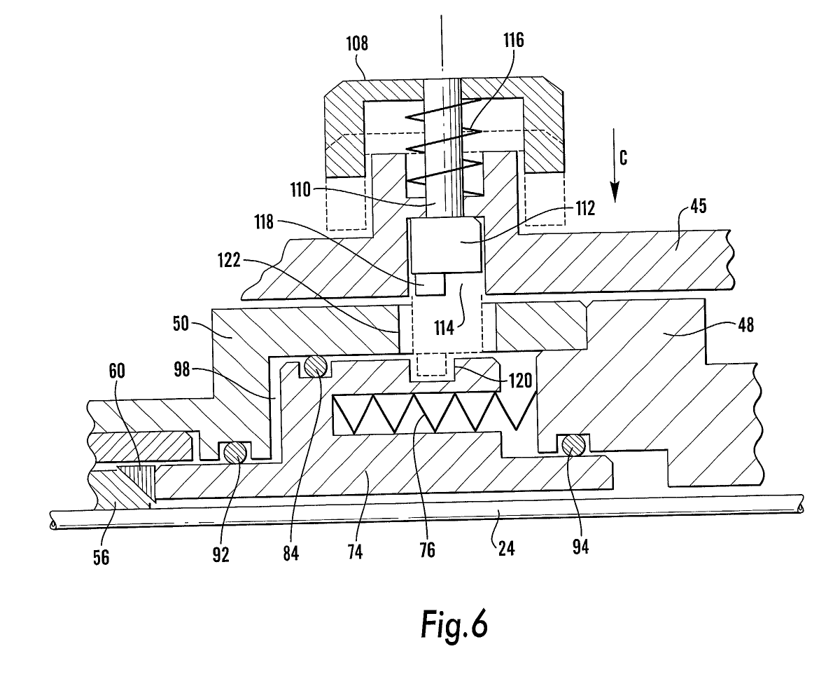

FIG. 6 is an enlarged sectional view of a further part of the EDM apparatus shown in FIG. 1 showing a manual actuation means for unclamping an electrode in an inoperative position; and

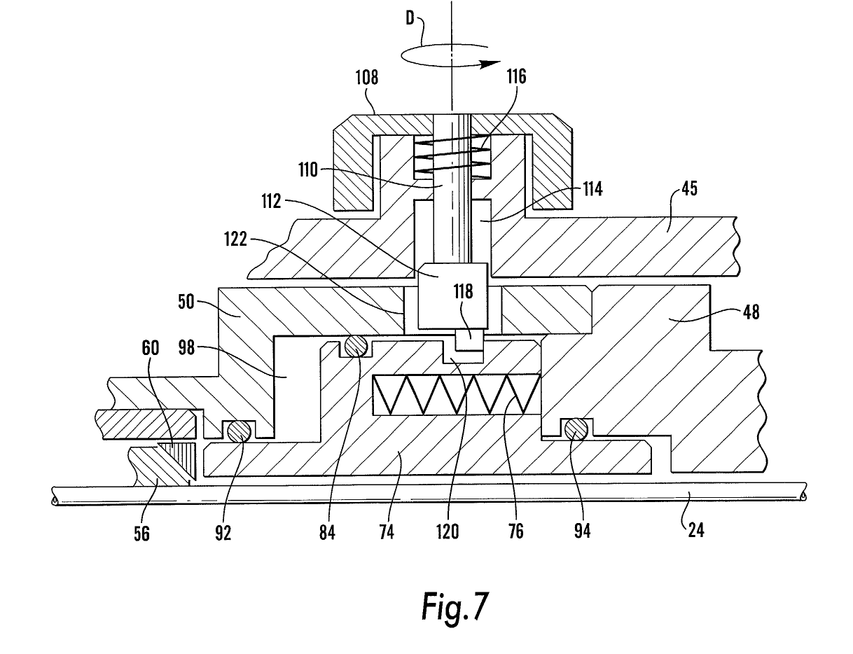

FIG. 7 is an enlarged sectional view as shown in FIG. 6, with the manual actuation means in an operative position.

Referring firstly to FIG. 1, an electrical discharge machining (EDM) apparatus is indicated generally at 10. The apparatus 10 comprises a nose guide assembly 12, which is fixed relative to a work piece 14 during machining of the work piece, and a main assembly, indicated at 16. The main assembly 16 is axially moveable relative to the nose guide assembly 12. Guide rods 18, one of which is shown, are releasably fastened to the main assembly 16 and nose guide assembly 12 by latches (not shown), which prevent accidental separation of the main assembly 16 and noseguide assembly 12 when removed from an EDM machine. An accurately machined positioning device 20 holds the nose guide assembly 12 relative to the work piece 14, and a further positioning device 22, supports the main assembly 16 on a reciprocating slide of the EDM machine (not shown) for axial movement in the direction of arrow A, as described above. Both of the positioning devices 20,22 are engaged in conventional manner by the EDM machine, which maintains the main assembly 16 and nose guide assembly 12 in axial alignment.

One end of a hollow electrode 24, mounted in the apparatus 10, is stored in an insulated storage tube 26 at one end of the main assembly 16. The storage tube 26 can be up to around 1 m in length. The electrode 24 passes though a central bore 25 of the main assembly 16, across a space 28 between the main assembly 16 and the nose guide assembly 12, through the nose guide assembly 12, and is supported close to the work piece 14 by the nose guide assembly 12.

The nose guide assembly 12 comprises a nose guide 30, having a bore 31 which supports the electrode 24, and an electrode clamp 32. The clamp 32 comprises a fixed lower jaw 31, and a movable upper jaw 33. The clamp 32 is actuated by a cylinder 34, having a piston 36 which acts on the movable upper jaw 33 of the clamp 32, in order to clamp the electrode 24. The piston 36 is mounted centrally in the cylinder 34, and therefore an electrode support 38, having a clearance bore for the electrode 24, is required to assist in ensuring correct alignment and support of the electrode 24 adjacent to the clamp 32. The support is conical on both sides, which assists in pre-location of the electrode 24 during use.

The main assembly 16 includes a shaft assembly 40, which rotates in bearings 42,44, about the central axis of the electrode 24. The electrode 24 rotates with the shaft assembly 40, as will be described below. The bearings 42,44 are mounted in a bearing housing 45, which is not electrically conducting. A drive pulley 46 is mounted at the right hand end of the shaft assembly 40, as viewed, and is driven by a variable speed motor through a drive belt (not shown). The shaft assembly 40 comprises a shaft 48, a shaft cylinder 50, and an end cap 52, which are described further with reference also to FIG. 3.

A second electrode clamp 54 is housed in the end cap 52 and comprises a pair of jaws 56 positioned between a front seat 58 and a rear seat 60. The jaws 56 can be seen also in FIGS. 2A to 2C and are part cylindrical. The jaws 56 are forced apart to their inoperative position by means of two pairs of springs 62,64. The springs 62,64 are held in recesses 66 provided in the jaws. The electrode 24 passes between the springs 62,64, which are conveniently positioned near the edges of the jaws 56. As can be seen in particular from FIG. 2C the ends of the jaws are chamfered at 68, to form wedge shapes. The front and rear seats 58,60 are formed as rings, each having a pair of recesses on one side, which receive and correspond in slope to the chamfers 68 at the ends of the jaws 56.

A deformable electrode seal 70 is positioned to the left-hand of the front seat 58, as viewed, and is retained in the end cap 52 by a seal guide 72. The electrode seal 70 is typically made of an elastomer and has a small clearance over the electrode 24 in its free state. The seal guide 72 acts as an anti-extrusion face for the seal 70, and guides the electrode 24 into the seal 70. The cap 52 is threaded to the shaft cylinder 50 for easy removal when changing over to a different electrode size range.

A piston 74 is mounted for reciprocating movement in the shaft cylinder 50. Clamp springs 76 are mounted in axial bores 78 in a central flange 80 of the piston 74. The springs 76 act against a shoulder 82 of the shaft 48 and tend to bias the piston 74 towards the clamp 54, causing the clamp to grip the electrode 24, as is discussed further below. A seal 84 is provided in a peripheral groove 86 of the piston 74, and seals between the central flange 80 of the piston, and an internal wall of the shaft cylinder 50. The ends 88, 90 of the piston 74 are of reduced diameter relative to the flange 80 and are sealed with respective seals 92,94 against internal walls of the shaft cylinder 50 and shaft 48. The ends 88, 90 of the piston 74 are of the same diameter.

A bore 96, shown in dotted outline in FIG. 3, provides a passageway from an external diameter of the shaft cylinder 50, to an internal chamber 98 between an endwall 100 of the shaft cylinder 50 and a front face 102 of the central flange 80. As can be seen from FIG. 1 the bore 96 connects with a air supply line 104 which supplies pressurised air through the bore 96 to the chamber 98. The air pressure acts to move the piston 74 in the direction of arrow B, shown in FIG. 3, against the action of the springs 76, which are compressed. This unclamps the clamp 54, as will be described further below.

Referring back to FIG. 1, a power input brush assembly 106 contacts the far right-hand end of the shaft 48, as viewed, and supplies electrical current to the shaft. The shaft assembly 40 is electrically insulated by the bearing housing 45 which is non conducting. The electrical current is conducted from the shoulder 82 of the shaft 48, through the springs 76 to the piston 74. When no air pressure is supplied to the cavity 98, and the springs are extended, as shown in FIGS. 4 and 5, the end of the piston 74 acts on the rear seat 60 of the clamp 54 which in turn acts on the chamfered ends 68 of the jaws 56, in the manner of a wedge. The jaws 56 are forced towards the electrode 24, and grip the electrode making an electrical connection. Thus, electrical current is conducted from the piston, through the rear seat 60 and the jaws 56 of the clamp 54, to the electrode 24.

The piston 74 can also be retracted manually against the action of the springs 76. Referring in particular to FIGS. 6 and 7, a manual unclamp knob 108 is mounted on the bearing housing 45. A shaft 110 extends from the knob 108, through a bore in the bearing housing 45, to a circular block 112, which is stowed in an inoperative position in a recess 114 provided in the side of the bearing housing 45. A spring 116 biases the knob 108 away from the bearing housing 45, and retains the circular block 112 in the recess 114. An eccentric pin 118 is provided on the lower face of the circular block 112. A second peripheral groove 120 is provided in the piston 74, and is dimensioned to receive the pin 118. An access hole 122 is provided in the periphery of the shaft cylinder 50 which, when aligned with the shaft 110 of the knob 108 allows access to the peripheral slot 120 in the piston 74.

In order to unclamp the electrode 24 manually, the access hole 122 is aligned with the shaft 110 of the knob 108, and the knob 108 depressed against the bias of the spring 116, until the pin 118 is located in the groove 120 of the piston 74, as shown in FIG. 7. The depression is indicated by arrow C in FIG. 6. The knob 108 is then rotated through 180E, as indicated by arrow D in FIG. 7, to the position shown. The eccentric pin 118 moves from the position shown in dotted outline in FIG. 6, to the position shown in FIG. 7, and by a camming action forces the piston 74 to move to the right, as viewed, against the bias of the springs 76. The size of the cavity 98 therefore increases, and the force applied to the rear seat 60 by the piston 74 relieved. Thus, the jaws 56 of the clamp 54 are released, and spring apart under the action of the springs 62,64 provided between the jaws.

Referring back to FIG. 1, a bore 124 is provided in a wall of the main assembly 16, which leads into an internal cavity 126 of the insulated storage tube 26. The bore 124 communicates with a high pressure supply of dielectric fluid, indicated schematically at 128, and the high pressure fluid is supplied through the storage tube 126 into the end of the hollow electrode 24. The fluid flows down the centre of the electrode 24, and exits at the cutting end, thus providing dielectric fluid for the machining process.

The operation of the (EDM) apparatus will now be described. The apparatus 10 is shown in FIG. 1 in a machining position. The clamp 32 of the nose guide assembly 12 is unclamped. No air pressure is applied to the chamber 98, and the manual unclamp knob 108 is in the inoperative position. Therefore, the clamp springs 76 bias the piston 74 towards the clamp 54, which consequently grips the electrode 24. Pressurised dielectric fluid is supplied through the bore 124 to the internal cavity 126 of the insulated storage tube 26, and is forced through the hollow electrode 24 to flush the cutting tip of the electrode at the workpiece 14. The electrode 24 is clamped before dielectric is supplied to the electrode, since the pressure of dielectric fluid acting on the end of the electrode, tends to push the electrode out of the (EDM) apparatus towards the workpiece 14.

When the bias of the clamp springs 76 is first applied, the end of the piston 74 contacts the rear seat 60, forcing the rear seat towards the jaws 56. The sloped recesses of the rear seat 60 engage the adjacent chamfered ends 68 of the jaws 56, and tends to force the jaws 56 together, in the manner of a wedge, against the bias of the springs 66, positioned between the jaws 56. The rear seat 60 and the jaws 56 are also forced axially towards the front seat 58 and the deformable seal 70. Consequently, the jaws 56 are trapped between the front and rear seats 58,60 and the sloped recesses of the front seat 58 tend to force the chamfered ends 68 at the other end of the jaws 56 together, also in the manner of a wedge. When the jaws 56 grip the electrode 24, and are prevented from further movement towards one-another, then the clamp is in the position shown in FIG. 4.

Further force applied to the piston 74, by the springs 76, causes further movement of the piston, front and rear seats 58,60, and jaws 56 towards the deformable seal 70. The seal 70 is prevented from axial movement by the seal guide 72, and is therefore caused to deform by pressure applied to the seal by the face of the front seat 58. The deformed seal 70, seals the space between the electrode 24 and the internal wall of the end cap 52, as shown in FIG. 5. The seal 70 prevents pressurised dielectric fluid supplied to the internal cavity 126 of the storage tube 26, from passing though the end of the cap 52, around the electrode 24. The compression forces on the electrode seal 70 are further enhanced by the fluid pressure acting on the area of the end face of the seal.

It should be understood that the electrode 24 is a clearance fit in the axial bore 25 through the apparatus 10, (which is one selected from a range of sizes). The clamp 54 and seal 70 are capable of clamping and sealing a range of sizes of electrode 24 respectively. This type of seal is also described in the applicant's co-pending PCT application PCT/GB 00/02086, published under the number WO 00/74886.

The shaft assembly 40 is driven by the variable speed motor and drive belt through the drive pulley 46, which rotates with the clamped electrode 24. Finally, electrical current is supplied to the electrode 24 through the shaft assembly 40, which is supplied through the power input brush assembly 106, in order to machine the workpiece 14.

As the electrode 24 and work piece 14 are eroded, the whole of the main assembly 16 is moved towards the workpiece 14 and fixed nose guide assembly by the slide (not shown). The main assembly 16 advances until there is no longer a space 28 between the end cap 52 and the nose guide 30, or until the space 28 is insufficient to allow a subsequent feature to be machined. At this point, machining must be suspended, and the electrode 24 replenished as follows.

Firstly, rotation of the shaft assembly 40 is stopped and the high pressure dielectric fluid supply to the storage tube 26 is staunched. The electrode clamp 32 is activated to grip the electrode 24 within the nose guide assembly 12. During this time the clamp 54 is still gripping the electrode 24 to stop the electrode from moving longitudinally.

Then, the clamp 54 is unclamped in order to allow the electrode 24 to move freely with respect to the main assembly 16. Unclamping of the electrode 24 is achieved by applying air pressure to the chamber 98 through the air supply line 104. A rotating seal 1O5, shown in FIG. 1, seals between the supply line 104 and the bore 96. The air pressure acts on the piston 74 and is sufficient to overcome the force exerted by the springs 74, and consequently moves the nose of the piston 74 away from the clamp 54. The springs 62,64 push the jaws apart, which makes the jaws and the rear seat 60 move in the same direction as the piston 74 until the electrode 24 is released.

The main assembly 16 retracts away from the nose guide assembly 2, withdrawing fresh electrode 24 from the storage tube 26. The slide stops retracting when sufficient electrode 24 is exposed in the space 28. The retraction distance is normally by a known fixed amount, which depends on the size of the electrode 24. A position-measuring device on the slide is conventionally used to monitor this distance.

The clamp 54 then re-clamps the electrode 24, as follows. The air pressure to the air supply line 104 is released, causing the piston 74 to be forced laterally, from right to left as shown in the drawing, by the action of the springs 76. The electrode 24 is then clamped by the clamp 54 as described previously. When the electrode 24 is gripped by the clamp 54, the electrical connection is made between the electrode 24 and the power input brush assembly 106, and the seal 70 is sealed against the high-pressure dielectric fluid. The electrode clamp 32 is then released in order to free the electrode 24 in the noseguide assembly 12.

To commence another machining cycle, rotation of the shaft assembly 40 is started, high-pressure dielectric fluid is supplied to the storage tube 26, and electrical power is applied to the electrode 24.

After completing a series of holes it may be necessary to change the electrode 24. It is possible that an amount of electrode 24 is exposed in the space 28 between the end cap 52 and the rear of the noseguide assembly 12. In order to remove the electrode 24 from the EDM apparatus, the electrode 24 has to be in the stow position, that is, moved back towards the storage tube 26, and not exposed in the space 28.

In order to change the electrode 24, the procedure is as follows. Firstly, rotation of the shaft assembly 40 is stopped, and the dielectric fluid supply is staunched. Then, the noseguide clamp 32 is activated to grip the electrode 24 within the noseguide assembly. During this time the clamp 54 is still gripping the electrode 24 to prevent undesired movement of the electrode. The clamp 54 is then unclamped, and the slide of the EDM machine advances to its stow position, that is, when the cap 52 of the main assembly 16 is close to the rear face of the nose guide assembly 12. The un-used electrode 24 is consequently returned back towards the storage tube 26. All of the services to the EDM apparatus are turned off apart from the pressurised air to the clamp 54, and the positioning devices 20,22 are released. The electrode 24 may then be withdrawn from the apparatus 10. The nose guide and main assemblies 12,16 are connected together by the guide rods 18 and their respective latches. Finally, the pressurised air to the clamp 54 is turned off. The procedure for loading of a different electrode 24 into the apparatus 10 is the reverse of the procedure for removing an electrode 24 from the apparatus 10.

The seal 70, front and rear seats 58,60 and the clamp 54 all are able to slide inside the bore of the cap 52. The seal guide 72, seal 70, front and rear seats 58,60, and clamp 54 are designed to accept a range of electrode sizes without the necessity for removal or adjustment. The assembly allows for electrodes within a 200-micron range, for example from 0.3 mm to 0.5 mm. A series of 15 clamp and seal assemblies cover a range of electrode sizes from 0.15 to 3 mm.

The facility to unclamp the electrode 24 manually, is usually used when the apparatus 10 is being serviced, for example, on a bench. The shaft assembly 40 is rotated by hand, assisted by spanner flats on the cap 52, until the access hole 122 in the shaft cylinder 50 lines up with the cylindrical block 112 and the eccentric pin 118 of the knob 108. The eccentric pin has a cam action which pushes the piston 74 away from the clamp 54, compressing the springs 76, and causing unclamping of the electrode as described earlier. The electrode 24 can then be adjusted or substituted and also the parts retained in the cap 52 can be exchanged. The manual unclamp knob 108 can then be rotated back, to allow the piston 74 to act on the clamp 54, and the return spring 116 in the manual unclamp knob assembly will return the knob 108 to the inoperative position.

Typically, an electrode 24 of the EDM apparatus 10 has an external diameter of 0.3 millimeters. With such a diameter of electrode 24, the maximum useable stroke, that is the maximum space 28 between the rear of the noseguide assembly 12 and the front of the cap 52, maybe as much as 60 millimeters. A fresh electrode 24 may be approximately 450 millimeters in length. With such an electrode 24, approximately six replenish cycles are possible, allowing for around 75 mm of wastage of electrode, due to the un-useable length of electrode 24 between the front end of the noseguide assembly 12 and the rear end of the clamp 54. With larger diameter electrodes 24, greater useable strokes are possible and the apparatus 10 is limiting. Smaller diameter electrodes 24 require that the maximum useable stroke, ie the space 28 is reduced to avoid having the electrode whip in the space 28 due to the rotation.

Typically, the electrode 24 is rotated at speeds of up to 1000 revolutions per minute. The high pressure dielectric fluid supply is typically around 70 bar.

The apparatus 10 provides the advantages of greater productivity, the use of longer electrodes thus reducing the potential need for human intervention, reduced inventory of parts due to the ability of the apparatus 10 to accept a range of electrode sizes, and ease of electrode change. All of these advantages reduce the cost of electrical discharge machining.

1. An electrical discharge machining apparatus including an electrode assembly having an electrode clamp which, in use, releasably clamps a hollow electrode held in the clamp, in use dielectric fluid being directed through the hollow interior of the electrode towards a workpiece, and a deformable seal for releasably sealing an annular space between the hollow electrode and the assembly, the seal being movable between a relaxed position in which dielectric fluid can pass through the annular space towards the workpiece and an operative position in which the seal is deformed into contact with the electrode thus preventing dielectric fluid from passing through the annular space, and means for actuating the seal for movement between the relaxed and operative positions, the electrode assembly being mounted for rotation about the axis of the hollow electrode, and the means for actuating the seal also actuating the clamp for releasably clamping the electrode.

2. An electrical discharge machining apparatus as claimed in claim 1, in which the electrode clamp makes an electrical contact with the electrode when in the clamped position.

3. An electrical discharge machining apparatus as claimed in claim 1 or claim 2, in which the electrode clamp and deformable seal are capable of receiving an electrode having an external diameter within a 200 micron range.

4. An electrical discharge machining apparatus as claimed in claim 3, in which the 200 micron range is between 0.3 mm and 0.5 mm.

5. An electrical discharge machining apparatus as claimed in any preceding claim, in which the electrode clamp and deformable seal can be removed from the assembly and replaced with a further electrode clamp and deformable seal suitable for a different range of electrode diameters.

6. An electrical discharge machining apparatus as claimed in any preceding claim, in which the actuating means is a piston.

7. An electrical discharge machining apparatus as claimed in claim 6, in which the piston acts in a first direction to operate the electrode clamp by means of springs, and acts in an opposite direction to release the electrode clamp by means of a pressurised fluid.

8. An electrical discharge machining apparatus as claimed in claim 7, in which the pressurised fluid is pressurised air.

9. A method of operating the electrical discharge machining apparatus as claimed in claim 1, comprising the steps of:
advancing the electrode assembly towards a nose guide assembly from a replenished position during machining of the workpiece, to a spent position,
suspending machining,
simultaneously unclamping the electrode and releasing the seal to the relaxed position in order to allow the electrode to move freely with respect to the electrode assembly, and clamping the electrode with a second clamp of the nose guide assembly, retracting the electrode assembly away from the nose guide assembly to the replenished position, thus withdrawing fresh electrode from a storage tube of the electrode assembly, unclamping the electrode, and finally re-clamping and resealing the electrode in the electrode assembly in order to recommence machining.

10. A method of operating as claimed in claim 9 in which a position-measuring device monitors the position of the main assembly relative to the nose guide assembly.
